(19) United States
(12) Patent Application Publication
(10) Pub. No.: US 2007/0055655 A1
(43) Pub. Date: Mar. 8, 2007

(54) Selective schema matching

(75) Inventors: Philip A. Bernstein, Bellevue, WA (US); John E. Churchill, Monroe, WA (US); Sergey Melnik, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/327,013

(22) Filed: Jan. 6, 2006

Related U.S. Application Data
(60) Provisional application No. 60/715,294, filed on Sep. 8, 2005.

(51) Int. Cl. G06F 17/30

(52) U.S. Cl. 707/3

(57) ABSTRACT

A system that automatically matches schema elements is provided. In one aspect, given a selected element of one schema, the system can calculate the best matching candidate elements of another schema. The calculation can be based on a heuristic combination of factors, such as element names, element types, schema structure, existing matches, and the history of actions taken by the user. Accordingly, the best candidate (according to the calculation) can be emphasized and/or highlighted. The tool can auto-scroll to the best choice. Similarly, the user can request the calculation and display to best candidates by pressing a keyboard key or hot key. As well, the user can prompt display of the best candidates by using the mouse (e.g., moving the mouse over the element E or clicking on E), or both (e.g., mouse over with hot key depressed).

### CROSS-REFERENCE TO RELATED APPLICATIONS

This application claims the benefit of U.S. Provisional Patent application Ser. No. 60/715,294 entitled “SELECTIVE SCHEMA MATCHING” and filed Sep. 8, 2005. This application is related to pending U.S. patent application Ser. No. 10/028,912 entitled “Systems and Methods for Model Matching” and filed Dec. 20, 2001. The entireties of the above-noted applications are incorporated by reference herein.

### BACKGROUND

Schema match is a schema manipulation operation that takes two schemas, models or otherwise structured data as input and returns a mapping that identifies corresponding elements in the two schemas. Schema matching is a critical step in many applications. For example, in e-business, schema match helps to map messages between different extensible markup language (XML) formats. In data warehousing, match helps to map data sources into warehouse schemas. In mediators, match helps to identify points of integration between heterogeneous databases. Schema integration uses matching to find similar structures in heterogeneous schemas, which are then used as integration points. Data translation employs some matching to find simple data transformations. Given the continued evolution and importance of these and other data integration scenarios, match solutions are likely to continue to become increasingly more important in the future.

Schema matching is challenging for many reasons. First and foremost, schemas for identical concepts may have structural and naming differences. In addition, schemas may model similar, but yet slightly different, content. Schemas may be expressed in different data models. Schemas may use similar words that may nonetheless have different meanings, etc.

Given these problems, today, schema matching is usually done manually by domain experts, sometimes using a graphical tool that can graphically depict a first schema according to its hierarchical structure on one side, and a second schema according to its hierarchical structure on another side. The graphical tool enables a user to select and visually represent a chosen mapping to see how it relates to the other remaining unmatched schema elements. At best, some tools can detect exact matches automatically, although even minor name and structure variations can lead them astray.

For a more detailed definition, a schema consists of a set of related elements, such as tables, columns, classes, XML elements or attributes, etc. The result of the match operation is a mapping between elements of two schemas. Thus, a mapping consists of a set of mapping elements, each of which indicates that certain elements of schema S1 are related to certain elements of schema S2. For example, a mapping between purchase order schemas PO and POrder may include a mapping element that relates element Lines.Item.Line of S1 to element Items.Item.ItemNumber of S2. While a mapping element may have an associated expression that specifies its semantics, mappings are treated herein as nondirectional.

A model or schema is thus a complex structure that describes a design artifact. Examples of models are Structured Query Language (SQL) schemas, XML schemas, Unified Modeling Language (UML) models, interface definitions in a programming language, Web site maps, make scripts, object models, project models or any hierarchically organized data sets. Many uses of models require building mappings between models. For example, a common application is mapping one XML schema to another, to drive the translation of XML messages. Another common application is mapping a SQL schema into an XML schema to facilitate the export of SQL query results in an XML format, or to populate a SQL database with XML data based upon an XML schema. Today, a mapping is usually produced by a human designer, often using a visual modeling tool that can graphically represent the models and mappings.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, comprises a system that automatically matches schema elements. In one aspect, given a selected element E of one schema, the system can calculate the best candidate elements of another schema that match E. The calculation can be based on a heuristic combination of several factors, such as element names, element types, schema structure, existing matches, and the history of actions taken by the user (e.g., the order in which the existing matches were created). Once matched, the very best candidate (according to the calculation) can be emphasized and/or highlighted.

In another aspect, the tool can auto-scroll to the very best choice. Similarly, in another aspect, the user can request the calculation and display the best calculated candidates by pressing a keyboard key or hot key, such as SHIFT. As well, the user can prompt display of the best candidates by using the mouse (e.g., moving the mouse over the element E or clicking on E), or both (e.g., mouse over with hot key depressed).

Using keyboard keys, such as up-arrow and down-arrow, the user can select the second best candidate, third best, etc., until the user has selected the desired match. Alternatively, navigation between match candidates can be done using mouse scrolling. The top match candidates can be displayed all at once, or alternatively, they appear on-demand as the user selects subsequent matches to display.

In still another aspect, the user can navigate between schemas. Using the right-arrow or left-arrow key, TAB key, etc., the user can move the selection to the candidate in the other schema in order to determine whether the candidate has better matches than E in E's schema. At any point during the process the user can confirm a choice by depressing a key, such as ENTER, or a mouse event, such as double-click, to indicate the choice of best match.

Instead of considering a single element E at a time, multiple elements E1, . . . , E_{M} can be selected and considered together for determining the best match candidates for E1, . . . , E_{M}, simultaneously exploiting the common context of the elements. The elements can be identified by choosing a single element with the intention that causes the children of that element to be matched. Also, after such a selection, the system can offer a pop-up menu of choices that influence the matching algorithm, such as match-by-name or match-by structure. Additionally, the system can be employed to match candidates between more than two schemas. For example, the system can be employed to match multiple elements between multiple schemas.

The selection of the elements for which the system can calculate candidate matches can be based on the user action history, the current “mode” of the tool (e.g., showing unmatched nodes only), pressing a keyboard key, choosing a menu item or clicking/dragging/hovering with the mouse. For example, if the user confirms the match candidate for some element, the next element to be selected could be the next element down the tree (or the children of the current schema element), or the next element (in the vicinity of the currently selected node or in the entire schema) that has a particularly good match candidate.

Highlighting of match candidates can be done using a variety of techniques. By way of example, a tool tip (e.g., showing the full path of the match candidate), coloring of the match candidate, putting a rectangle around it, placing labels (e.g., bearing the match score) on lines connecting the selected element to the match candidates, highlighting the lines using color, thickness, line type (e.g., dotted, dashed) or shape using coalescing (e.g., retaining the match candidates and the relevant context nodes only and hiding irrelevant nodes to avoid clutter) can be employed.

Calculation of best match candidates can be effected “on-the-fly” (e.g., upon element selection), as a background process, using a pre-computed (e.g., cached) index over schema elements and/or previous matches or the like. It is a particularly novel feature of the subject system to employ a calculation based on name, structure, type, existing matches, and the history of user actions in addition to, or in place of, an exact match based on name as used in conventional systems. Taking the existing matches and/or the user action history into account can particularly make the process of mapping creation interactive and personalized.

Moreover, given a partial mapping between elements of the first schema and elements of the second schema, when computing the candidates to match element E of the first schema, the subject system can bias the choice toward the neighborhood of elements of the other schema that currently match elements that are in the neighborhood of E. Moreover, other aspects can additionally bias the choice toward the most recently matched (or viewed, expanded) elements. Still other aspects are directed to the idea that the schema matching algorithm calculates only the matches between the selected element(s) of one schema and all the elements of the other schema. In still another aspect, element annotations can be employed by an alternative matching algorithm.

In yet another aspect thereof, an artificial intelligence component is provided that employs a probabilistic and/or statistical-based analysis to predict or infer an action that a user desires to be automatically performed.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a system that facilitates automatically matching schema elements in accordance with an aspect of the invention.

FIG. 2 illustrates an exemplary flow chart of procedures that facilitate automatically matching elements between schemas in accordance with an aspect of the invention.

FIG. 3 illustrates a system that employs a mapping component to match elements of disparate schemas in accordance with an aspect of the invention.

FIG. 4 illustrates a match selection component that facilitates navigation between elements and auto-matches in accordance with an aspect.

FIG. 5 illustrates an exemplary screen shot of an emphasized element auto-match in accordance with an aspect.

FIG. 6 illustrates an exemplary screen shot of the matches of FIG. 5 whereby a user toggles between matches.

FIG. 7 illustrates an exemplary screen shot that shows an additional element auto-match after confirming the match of FIG. 6 in accordance with an aspect of the invention.

FIG. 8 illustrates an exemplary screen shot of releasing the hot key in accordance with FIG. 7.

FIG. 9 illustrates an exemplary screen shot of depressing the right arrow key with respect to the state of FIG. 5.

FIG. 10 illustrates a block diagram of a computer operable to execute the disclosed architecture.

FIG. 11 illustrates a schematic block diagram of an exemplary computing environment in accordance with the subject invention.

### DETAILED DESCRIPTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms “screen,” “screen shot,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

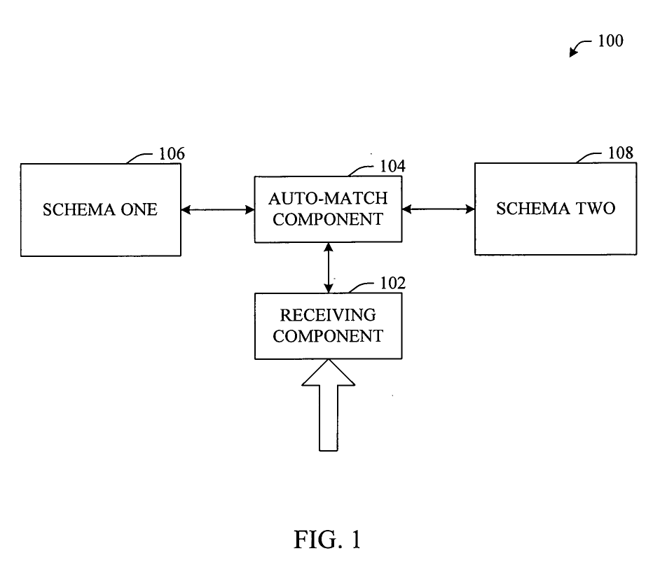

Referring initially to FIG. 1, a system 100 that facilitates automatically and/or dynamically matching schema elements in accordance with an aspect of the invention is shown. Generally, the system includes a receiving component 102 and an auto-match component 104. In operation, the receiving component 102 receives an input with respect to an element (or group of elements) in a first schema (e.g., schema one 106). Accordingly, the auto-match component 104 can map the selected element related to schema one 106 to an appropriate element (or group of elements) in a second schema (e.g., schema two 108). Although only two schemas are illustrated in FIG. 1, it is to be understood that the novel features of the subject invention can be employed with any number of schemas thereby automatically matching elements between multiple schemas.

As will be described in greater detail infra, various methods of selecting an initial schema element as well as navigating through automatically mapped matches can be employed; these mechanisms are to be included within the novel spirit and scope of the invention and claims appended hereto. For example, selection and navigation techniques can include, but are not limited to, pointing devices, keystrokes, function keys, touch screens or the like.

A schema can be a template for data instances. Common types of schemas can include extensible markup language (XML) schemas, relational (e.g., structured query language (SQL)) schemas, ontology schemas (e.g., resource description framework (RDF) schema or web ontology language (OWL)), and object-oriented (e.g., common language runtime (CLR)) schemas. As illustrated in FIG. 1, given two schemas (e.g., 106, 108), the systems and methods described herein can facilitate automatically developing a mapping from the first schema 106 to the second schema 108.

The mapping can be ultimately compiled into code to transform instances of the first schema 106 into instances of the second 108. Although the aspects described herein are explained in terms of schemas, it is to be appreciated that the same or similar problems arise in mapping other kinds of models which are not database schemas or in mapping instances of models. By way of example and not limitation, other models are directed to unified modeling language (UML) models, form models, business rule models, business domain models, or business process models. Examples of instances of models are XML documents and business forms. These additional aspects are to be considered a part of this disclosure and within the scope of the claims appended hereto.

One focus of this application is to assist a user to produce the mapping of elements from one schema to another (e.g., 106 to 108). In one more specific example, this automatic mapping can be performed with the assistance of a visual programming tool, such as BizTalk Mapper-brand application. In this example, the display can be split into three (or more) vertical panes.

Accordingly, the two schemas (106, 108) can be displayed in the left and right panes respectively. As will be better understood upon a review of the figures that follow, the system can facilitate automatic generation of graphical elements in the middle pane (e.g., lines, cells, functoids, drop down boxes) to describe how elements of the left schema (e.g., 106) should be mapped to elements of the right schema (e.g., 108). One novel aspect of the present invention is a technique for facilitating this process by having the tool automatically generate candidate matches from which the user can choose.

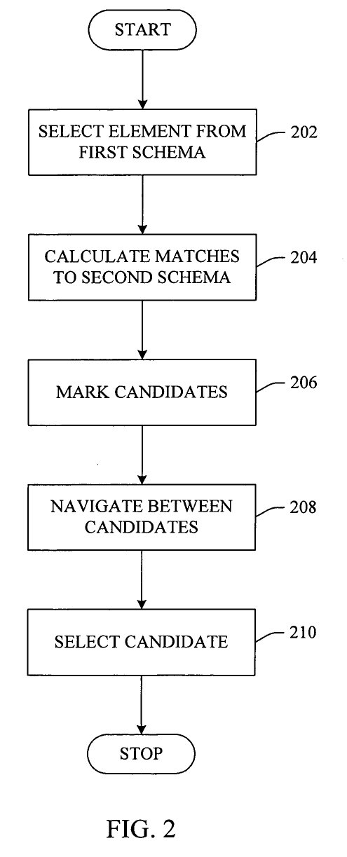

FIG. 2 illustrates a methodology of automatically matching schema elements in accordance with an aspect of the invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 202, an element is selected from a first schema. Given a selected element E of one schema, at 204, the system can calculate the best candidate elements of the other schema that match element E. It is to be understood and appreciated that the calculation can be based on a heuristic combination of several factors including, but not limited to, such factors as element names, element types, schema structure, existing matches, and the history of actions taken by the user (e.g., the order in which the existing matches were created).

In one aspect, at 206, the best candidate (according to a calculation) can be highlighted or marked in a conspicuous manner such that the user can identify the best calculated candidate. At 208, a user can navigate through the matches and, at 210, a candidate can be selected. It is to be understood that, in one aspect, auto-scrolling can be employed to select the best candidate. In another aspect, a user can request the calculation and display to best candidates by pressing a keyboard key or hot key, such as “SHIFT”, or using the mouse (e.g., moving the mouse over the element E or clicking on E), or both (e.g., mouse over with hot key depressed).

Returning to act 208, a user can navigate between match candidates in a variety of manners. For example, via keyboard keys, such as up-arrow and down-arrow, the user can select the second best candidate, third best, etc. Alternatively, navigation between match candidates can be accomplished using mouse scrolling. In this example, the top match candidates can be displayed all at once, or alternatively, the matches can appear on-demand as the user selects subsequent matches to display. Moreover, a user can navigate between schemas. For example, in one aspect, using the right-arrow or left-arrow key, or the TAB key, a user can move the selection to the candidate in the other schema in order to determine whether the candidate has better matches than E in E's schema.

At any point in the process a user can confirm matches. For example, the user can employ a key, such as ENTER, or a mouse event, such as double-click, to indicate the choice of best match. Although candidate selection is illustrated as act 210, it is to be understood that the acts illustrated can be employed in any order in addition to the order illustrated in FIG. 2.

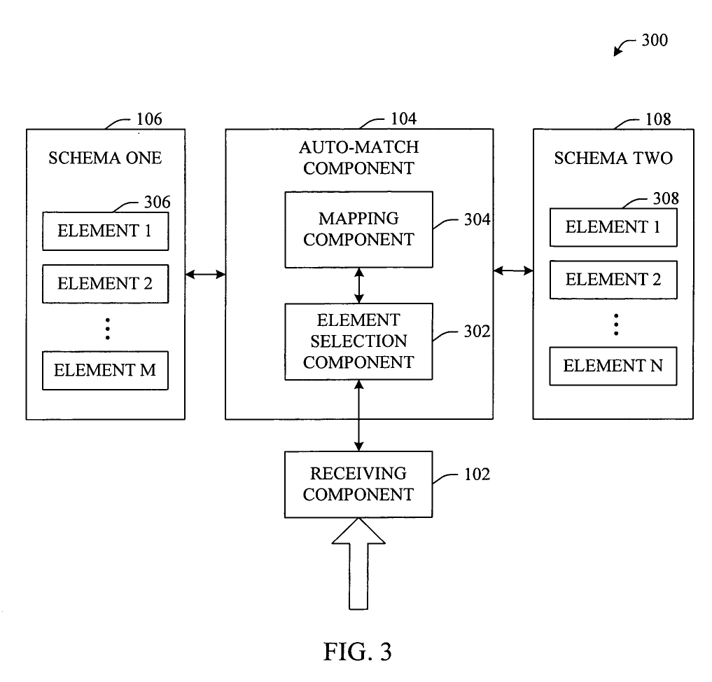

Referring now to FIG. 3, an alternative system 300 of automatically matching schema elements is shown. As shown, auto-match component 104 can include an element selection component 302 and a mapping component 304. The element selection component 302 can facilitate selecting one or more elements from a first schema (e.g., 106). As shown, schema one 106 can include 1 to M schema elements, where M is an integer. Similarly, schema two 108 can include 1 to N schema elements, where N is an integer. These elements can be referred to collectively or individually as schema elements 306, 308 respectively.

In an alternative example, rather than considering a single element E from schema one 106, multiple elements E₁, . . . , Eₚ can be selected and considered together for determining the best match candidates for E₁, . . . , Eₚ, simultaneously exploiting the common context of the elements. The elements can be identified by choosing a single element with the intention that causes the children of that element to be matched. Also, after such a selection, the system can offer a pop-up menu of choices that influence the matching algorithm, such as match-by-name or match-by structure. As stated supra, the mapping component 304 and the element selection component 302 can calculate candidate matches based at least in part upon the user action history, the current “mode” of the mapping component 304 (e.g., showing unmatched nodes only), pressing a keyboard key, choosing a menu item or clicking/dragging/going over with the mouse. For example, if the user confirms the match candidate for some element, the next element to be selected could be the next element down the tree (or the children of the current schema element), or the next element (e.g., in the vicinity of the currently selected node or in the entire schema) that has a particularly good match candidate.

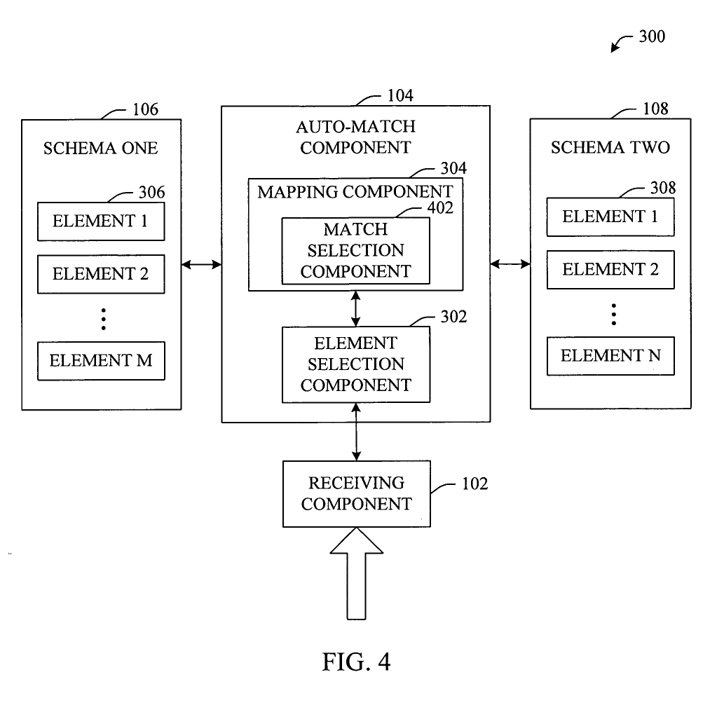

Turning now to FIG. 4, an alternative architectural diagram of system 300 is shown. More particularly, as illustrated in FIG. 4, auto-match component 104 can include a match selection component 402. In accordance with highlighting match candidates, match selection component 402 can employ a variety of techniques including, but not limited to, a tool tip (e.g., showing the full path of the match candidate), coloring of the match candidate, putting a rectangle around the match candidate, placing labels (e.g., bearing the match score) on lines connecting the selected element to the match candidates, highlighting the lines using color, thickness, line type (e.g., dotted, dashed) or shape, using coalescing (e.g., retaining the match candidates and the relevant context nodes only and hiding irrelevant nodes to avoid clutter), using scrollbar ticks or the like. It is to be understood that, in accordance with disparate aspects, calculation of match candidates can be performed on-the-fly (e.g., upon element selection via element selection component 306), as a background process, or using a precomputed (cached) index over schema elements and/or previous matches.

Although some limited “schema matching algorithms” for determining a mapping between all the elements of one schema and all the elements of the other schema exist, it is important to note that the subject system(s) can employ a novel heuristic calculation based upon name, structure, type, existing matches, and the history of user actions. In other words, the subject system, and more particularly the auto-match component 104, employs additional factors rather than merely taking into account an exact match of an element name when calculating matches as employed by conventional systems. It is to be understood that, taking the existing matches and/or the user action history into account makes the novel process of mapping creation interactive and personalized.

For example, given a partial mapping between elements 306 of the first schema 106 and elements 308 of the second schema 108, when computing the candidates to match element E of the first schema 106, the system can bias the choice toward the neighborhood of elements of the other schema 108 that currently match elements that are in the neighborhood of E. In another aspect, bias can be given to the choice toward the most recently matched (or viewed, expanded) elements. It is to be understood and appreciated that, in one aspect, the subject schema matching system and algorithm calculates only the matches between the selected element(s) 306 of one schema 106 and all the elements 308 of the other schema 108.

With continued reference to FIG. 4, system 300 is a schema matching system. More particularly, system 300 can refer to a mechanism used in a schema mapping tool. The system 300 can be best understood via a usage scenario. Accordingly, an exemplary scenario is described below. It is to be understood that this scenario is provided to add context to the invention and is not intended to limit the functionality and/or novelty of the subject invention. It is further to be understood that other aspects and scenarios can exist that employ the novel features of the subject system 300. These alternative aspects and scenarios are to be included within the scope of this disclosure and claims appended hereto.

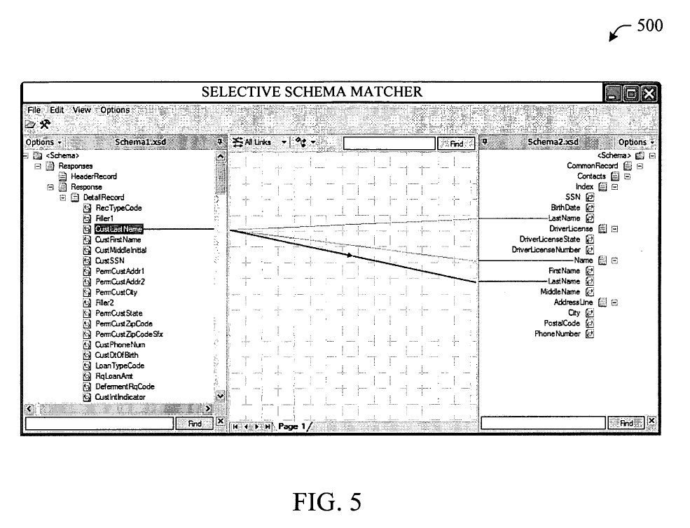

In operation, a user can select an element E (e.g., 306, 308) from one of the two schemas (e.g., 106, 108) by highlighting it. The user can then press a key (e.g., “hot key”), such as SHIFT, to prompt the system 300, and more particularly the auto-match component 304, to generate candidate matches. The system 300 can employ a schema-matching algorithm (via auto-match component 104) to calculate the best candidates and display a number of them on the screen as lines from E to the candidate elements. The best candidate according to the system's calculation is highlighted, for example in red. These display functionalities will be better understood upon a review of FIGS. 5-9 that follow.

Continuing with the exemplary scenario, the user can scroll through the candidates using the keyboard, for example, by using the up-arrow and down-arrow keys. Additionally, any other mechanism (e.g., navigation device, mouse) or auto-scrolling technique can be employed to scroll through the matches.

In the scenario of using the arrow keys to scroll through the candidates, the candidates can be selected in order of goodness. For example, the first press of the down-arrow key can move the selection to the second-best candidate (according to the system's calculations). Accordingly, the next press of the down-arrow key can transfer to the third best and so on.

After the user has selected the candidate C that is the desired match, another selection key can be depressed to confirm the selection. For example, the ENTER key can be depressed to “confirm” selection C thereby causing it to become part of the mapping. That is, the line from E to C becomes permanent and the lines for matches of E to other candidates disappear and/or are de-emphasized. Once confirmed, the tool now moves to the next element after E. Moreover, if the hot key (e.g., SHIFT) is still depressed, the system immediately calculates the candidate matches for this new selection, as described supra. Thus, the user can match one element after another rather quickly, with very few keystrokes and little or no mouse movement. It is to be understood that the auto-match feature described above is not intrusive. In other words, the user presses the hot key to see if the system produces useful matches. If not, the hot key can be simply released.

Furthermore, as described above, the system 300 can display only a small number of matches. In accordance therewith, the user can select those matches one at a time. If the user selects the last of the candidate matches that have been displayed and then presses the down-arrow key, the system 300 can display the next best match and select it. Thus, the system 300 does not overly clutter the screen with too many candidate matches. However, if desired, the system 300 can afford the user the opportunity to see more candidates.

An aside regarding the above paragraph, if C is calculated to be the best candidate to match E, and E is calculated to be the best candidate to match C, then the match can be called a “stable marriage,” because neither element prefers another match over the one it is currently assigned. However, since the match calculation is heuristic, there is still no guarantee that this stable marriage is the correct match that the user desires. It merely means that for the two elements E and C, the match calculation yields a symmetric result.

The candidates described above may be elements of the other schema or elements of the mapping that has been developed thus far. For example, the candidates may be functoids in the mapping. In one aspect, the best use could be to match elements of the other schema. However, as tools become more powerful and more complex mappings are considered, it may become equally important for the automated match calculation to identify elements of the mapping as well. These alternative systems are to be considered within the scope of this disclosure and do not depart from the spirit and scope of the novel functionality described herein.

The novel features described above, in one aspect, can make it possible for a user to walk through all the elements of one schema, matching each one in turn, without requiring the user's hands to leave the keyboard to employ a pointing device (e.g., mouse). That is, the user can first use the pointing device to select the first element of the schema. Subsequently, the user can employ one hand to depress a hot key, and the other hand to use the arrow keys to select the best candidate. If one of the candidates is desired, then by pressing ENTER the selection can be confirmed and the system automatically moves to the next element. If none of the candidates are desired, then the hot key can be released and the down-arrow depressed to move to the next element to consider. The hot key can be depressed again to see candidate matches for this next element and so on.

In a variation of the above scenario, the user can press the left-arrow or right-arrow key (depending on which schema contains E), thereby moving the selection to the currently-selected candidate element C in the other schema. In addition to changing the selected element to be C, the system can automatically calculate the best matches (e.g., E1, E2 and E3) of C to elements of E's schema. Now, the user can decide whether any of the candidate elements (E1, E2, and E3) are better choices to match with C than E.

In summary and in operation in accordance with an aspect of the novel innovation, a user can select an element in a schema. Next the user can depress a hot key, e.g., SHIFT, to see candidate matches. The best match (if there is one) is highlighted and/or emphasized (e.g., in red). While pressing SHIFT, the user can depress a confirmation key (e.g., ENTER) to confirm the highlighted match. The up-down arrow keys can be employed to cycle through the matches in order of goodness. If the down-arrow is depressed on the last match, the system will reveal another match. The left-right arrow keys can be employed to move to the target element of the emphasized link and to reveal the best matches of that element. The former emphasized link is retained even if it is not one of the best matches of the target element. Therefore, the user can employ the left-right arrow key to quickly navigate back to the original element.

Furthermore, in another aspect, a HOME key can be employed to return to the top match. In another aspect, a LinkByPath option can be added to the popup menu that appears after connecting an internal element e1 of one schema to an internal element e2 of the other. This LinkByPath can particularly address two potential issues. Specifically, it can handle group nodes well (e.g., <sequence>) and can automatically expand children of e1 and e2 whose “tree nodes” were not previously created.

Following is a discussion of still another aspect of the subject novel functionality. Given a selected node in one schema, pressing SHIFT, or other designated key, can display the most likely match candidates in the other non-selected schema. The algorithm can have two phases. Phase one is a “pre-filter” that uses text-based matching to identify candidate nodes that are worth the more expensive calculation of phase two. Phase two can use a combination of text, structure and type to calculate the similarity of the candidates that survived phase one and can pick those with highest similarity to display. If one node has higher similarity than all the others, it can be emphasized and/or displayed in red.

In the aspect, phase one tokenizes the node name based on camel case and delimiters. It then uses n-gram or prefix matching on the tokens. An n-gram is a sequence of n consecutive characters in a string. For example, the 3-grams of “phase” are “pha”, “has”, and “ase”. For each node x of the non-selected schema, if any 3-gram of a token of x matches a 3-gram of a token of the selected node, then x is a candidate. If the pre-filter identifies no candidates, then no candidate matches are displayed. Otherwise, the algorithm proceeds to phase two to pick the best candidates.

Phase two can rank the candidates by scoring each candidate match based on textual similarity, structural similarity and type. For example, phase two can rank the candidates based upon textual similarity which is based on three main calculations. For each element E, the first calculation computes a list of weighted tokens for e's name. The list includes the element name, tokens based on camel case and delimiters, short prefixes of tokens, and capital letters, all with different weights. The second calculation computes, for a given element x, a list L(x) of weighted tokens for the names of all elements e on the path from the root to x. The farther an element e is from x, the more e's weight is reduced. The third calculation computes the textual similarity of the selected element s and a candidate element c as the sum of the weights of L(s)∩L(c).

Structural similarity is measured by the distance score, which is the number of neighbors of the candidate that are linked via the current mapping to neighbors of the selected element. More specifically, suppose neighbors(x) is the set of elements of x's schema that are the ancestors and siblings of element x. Suppose linkedSet(y) is the set of elements in the other schema (i.e., not y's schema) that are linked to y either directly or indirectly through transformations. Then the distance score of selected element s and candidate element c is the cardinality of (neighbors(s)∩linkedSet(neighbors(c))).

In accordance with the aspects, for each candidate, the textual similarity and distance similarity can be reduced if the candidate has a different type than the selected element. As well, each candidate's total similarity to the selected element can be computed as a weighted sum of textual and structural similarity. Moreover, each candidate's similarity scores can be normalized to a value in [0,1] based on the maximum value of each kind of score.

Additionally, each candidate's total similarity score can be incremented by the similarity of each of the candidate's ancestors to the selected node. This bias can enable the algorithm to choose a child rather than its parent when both match. By way of example, if Name and its child FirstName both match the selected element, then FirstName is preferred. The candidates with the top total scores are displayed. If one element has the absolute highest score, it can be emphasized, for example, displayed in red.

Turning now to FIGS. 5-9, exemplary graphical representations (e.g., screenshots) that correspond to the aforementioned novel functionality are shown. Referring first to FIG. 5, a screenshot 500 of displaying candidate matches after pressing a hot key is shown.

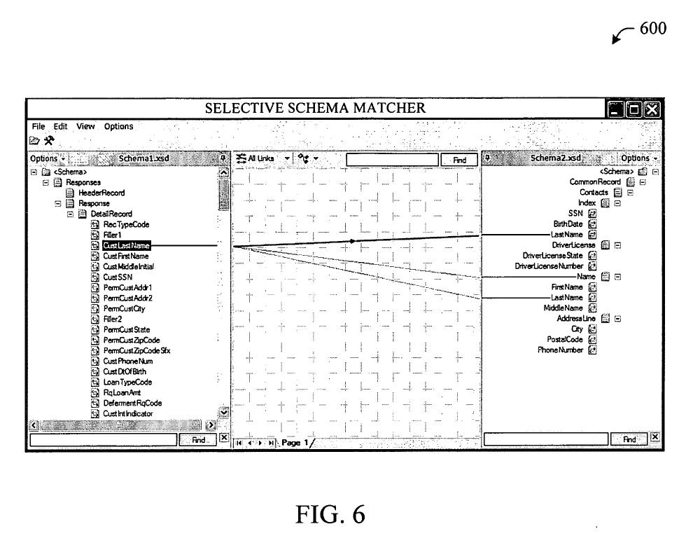

As illustrated in the example of FIG. 5, upon pressing a hot key, the system can display three candidate matches, where hot key could be, for example, SHIFT, CTRL, or another special key. As shown, one of the matches is emphasized by a heavier weight (or different color) line. Upon depressing the down arrow key when viewing the state shown in FIG. 5, the system emphasizes the next best candidate as shown in the screenshot 600 of FIG. 6.

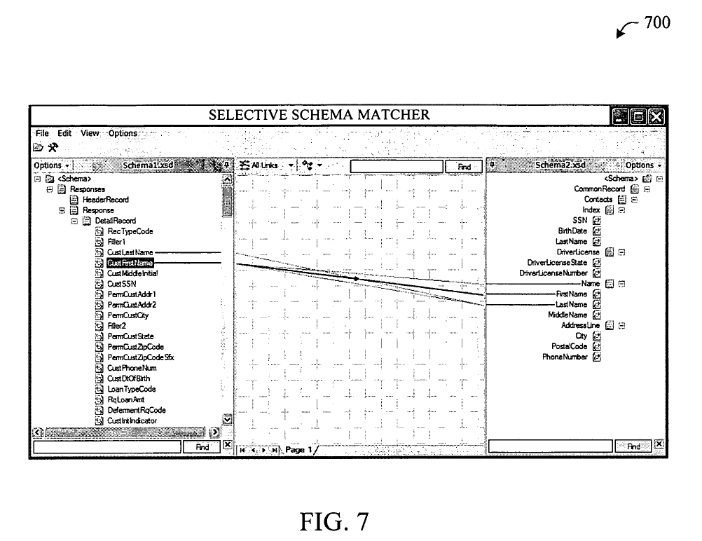

Turning now to FIG. 7, after pressing a confirmation key (e.g., ENTER) in accordance with the state of FIG. 6 (while still depressing the hot key) the emphasized match is confirmed. More particularly, the confirmation action causes the system to “confirm” the mapping of Responses/Response/DetailRecord/CustLastName in Schema1.xsd to CommonRecord/ContactRecord/Contacts/Name/LastName in Schema2.xsd, and to erase (or de-emphasize) the other candidate mappings from Responses/Response/DetailRecord/CustLastName in Schema1.xsd to Schema2.xsd. In addition, without any further keystrokes, the system advances to the next element of Schema1.xsd, namely CustFirstName, and displays candidate matches for that element since the hot key is still depressed as shown in FIG. 7.

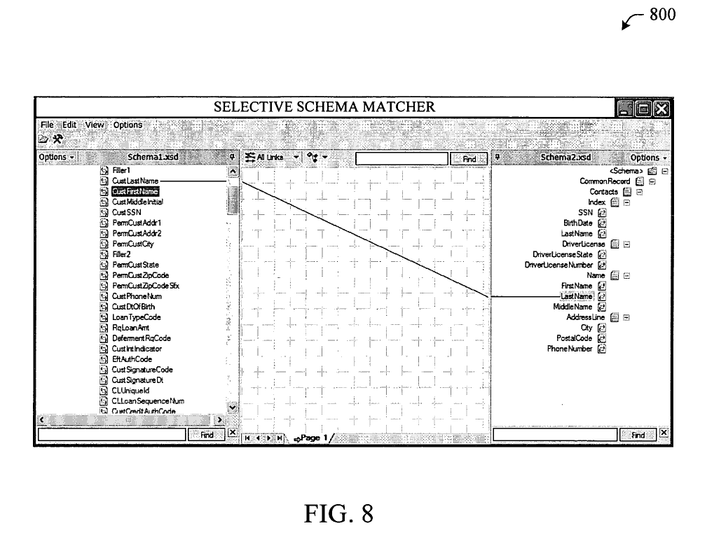

With continued reference to FIG. 7, while in the state of screenshot 700, if the user is not interested in finding a match for CustFirstName in Schema1.xsd, the hot key is simply released causing the candidate matches for CustFirstName to disappear, as shown in screenshot 800. It is to be appreciated that the mapping that was confirmed in FIG. 5 is still present in FIG. 8.

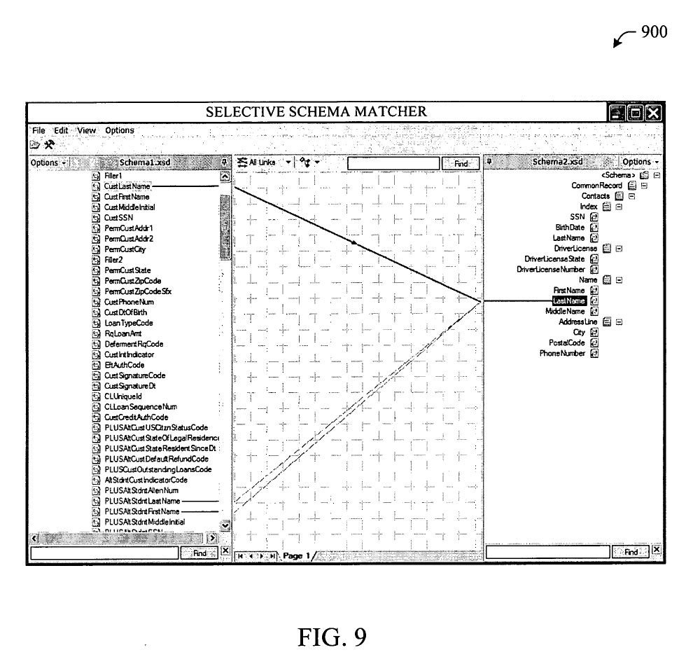

Referring now to FIG. 9, a screenshot 900 of depressing the right arrow key with respect to the state of FIG. 5 is shown. More particularly, in accordance with the state of FIG. 5, the user can find other candidates that match CommonRecord/ContactRecord/Contacts/Name/LastName in Schema2.xsd by depressing the right arrow key, while still holding the hot key. The result of this action is illustrated in the screenshot 900 of FIG. 9.

Notice that Responses/Response/DetailRecord/CustLastName in Schema1.xsd is emphasized as the best match for LastName in Schema2.xsd. As such, this match can be considered a “stable marriage.” In an alternative aspect of the invention, the match between LastName and CustLastName would continue to be highlighted even if it were not the best candidate match for LastName, simply to enable easy navigation back to CustLastName (e.g., without having to use the down arrow key to select the candidate match of LastName and CustLastName). If the user depresses the left arrow while in the state of FIG. 9, the system can automatically return to the state of FIG. 5.

In an alternative aspect, a rules-based logic component can be employed to automate an action a user desires to perform. In accordance with this alternate aspect, an implementation scheme (e.g., rule) can be applied to define and/or implement a matching operation. In response thereto, the rule-based implementation can select a schema element(s) included within the schema(s) by employing a predefined and/or programmed rule(s) based upon any desired criteria (e.g., type, name).

In still another alternative aspect, the system can employ an artificial intelligence (AI) which facilitates automating one or more features in accordance with the subject invention. The subject invention (e.g., in connection with selection) can employ various AI-based schemes for carrying out various aspects thereof. For example, a process for determining which elements to select and/or which elements to match can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of schema elements, for example, attributes can be words or phrases or other data-specific attributes derived from the words (e.g., presence of key terms), and the classes can be categories or areas of interest (e.g., levels of priorities).

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to predetermined criteria when to select a schema element, when to match disparate schema elements, when to confirm a match, etc.

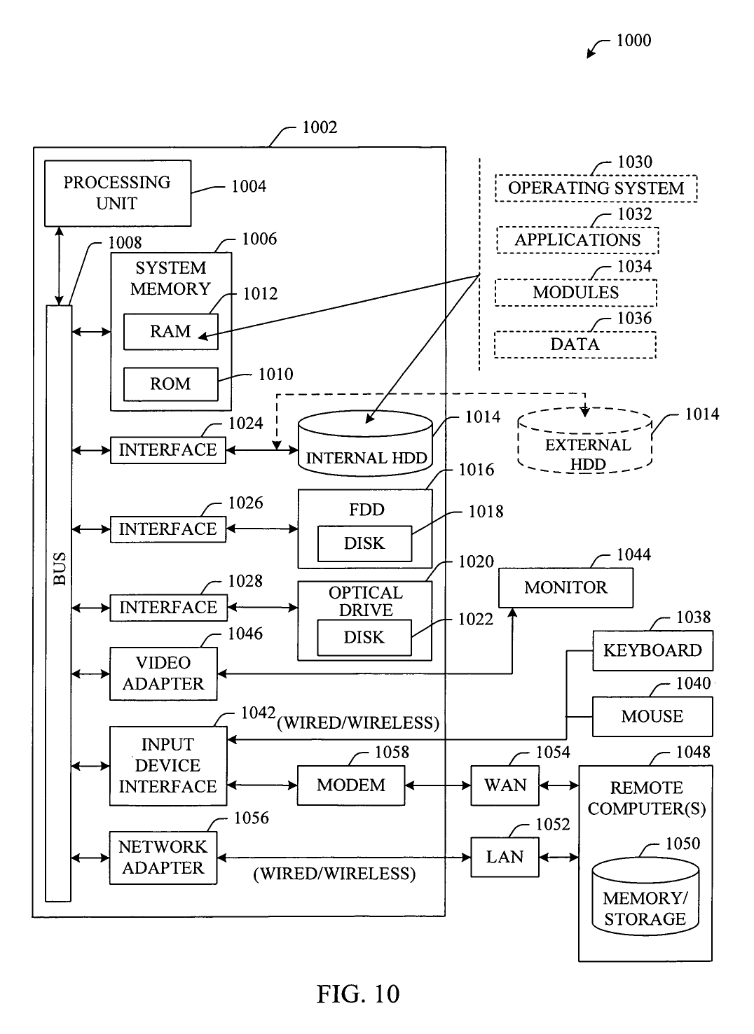

Referring now to FIG. 10, there is illustrated a block diagram of a computer operable to execute the disclosed architecture. In order to provide additional context for various aspects of the subject invention, FIG. 10 and the following discussion are intended to provide a brief, general description of a suitable computing environment 1000 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

With reference again to FIG. 10, the exemplary environment 1000 for implementing various aspects of the invention includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the invention can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

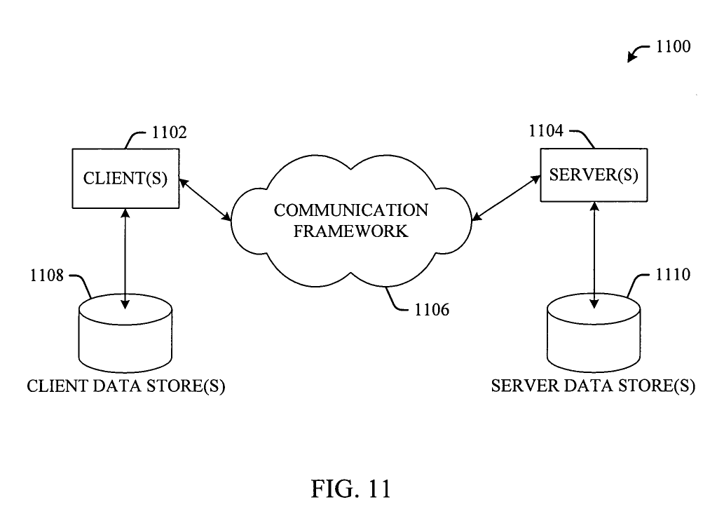

Referring now to FIG. 11, there is illustrated a schematic block diagram of an exemplary computing environment 1100 in accordance with the subject invention. The system 1100 includes one or more client(s) 1102. The client(s) 1102 can be hardware and/or software (e.g., threads, processes, computing devices). The client(s) 1102 can house cookie(s) and/or associated contextual information by employing the invention, for example.

The system 1100 also includes one or more server(s) 1104. The server(s) 1104 can also be hardware and/or software (e.g., threads, processes, computing devices). The servers 1104 can house threads to perform transformations by employing the invention, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates automatically matching schema elements, comprising:
a receiving component that receives a selection of a first element that is a component of a first schema; and
a match component that automatically matches the first element to a second element is a component of a second schema.

2. The system of claim 1, the match component automatically matches the first element to a third element of the second schema.

3. The system of claim 1, further comprising a mapping component that generates one or more heuristically-based matches between the first element and one or more elements of the second schema; the match component facilitates function key navigation between the one or more matches.

4. The system of claim 3, the mapping component ranks one or more matches based at least in part upon one of textual similarity, structural similarity, type and history of user actions.

5. The system of claim 4, the structural similarity is based at least in part upon a distance score; the distance score is based at least in part upon a number of neighbors of a candidate that are linked via a current mapping to neighbors of the first element.

6. The system of claim 4, the match component emphasizes a top-ranked match based at least in part upon predefined match criteria.

7. The system of claim 6, further comprising a selection component that facilitates scrolling through the one or more matches and selecting a desired match.

8. The system of claim 1, further comprising an artificial intelligence (AI) component that infers an action that a user desires to be automatically performed.

9. A computer-implemented method of matching schema elements, comprising:
receiving a selection that corresponds to a first element in a first schema;
automatically matching the first element to one or more elements in one or more disparate schemas; and
navigating through the one or more matches.

10. The computer-implemented method of claim 9, the act of navigating is enabled via at least one of a keyboard and a pointing device.

11. The computer-implemented method of claim 9, further comprising heuristically matching the first element to one or more elements related to the second schema.

12. The computer-implemented method of claim 11, further comprising ranking one or more matches based at least in part upon textual similarity, structural similarity, type and history of user actions.

13. The computer-implemented method of claim 12, further comprising tokenizing the first element to facilitate matching to the one or more elements of the second schema.

14. The computer-implemented method of claim 13, further comprising emphasizing a top-ranked match based at least in part upon predefined match criteria.

15. The computer-implemented method of claim 14, the act of emphasizing includes at least one of highlighting the best match, coloring the best match, labeling the best match and conspicuously denoting a line characteristic of the best match.

16. The computer-implemented method of claim 15, the line characteristic is at least one of color, thickness, shape and style.

17. The computer-implemented method of claim 14, further comprising navigating through the one or more matches and selecting at least one of the one or more matches.

18. A computer-executable system that facilitates selective schema matching, comprising:
computer-implemented means for selecting a first set of elements of a first schema;
computer-implemented means for automatically matching the first set of elements with a second set of elements of a second schema; and
computer-implemented means for rendering a hierarchical representation of the matches that highlights a subset of the matches based at least in part upon a matching algorithm.

19. The computer-executable system of claim 18, further comprising computer-implemented means for traversing through the matches and means for selecting at least one of the matches.

20. The computer-executable system of claim 18, further comprising an artificial intelligence (AI) component that employs a probabilistic-based analysis to infer an action that a user desires to be automatically performed.
